(19) United States
(12) Patent Application Publication
(10) Pub. No.: US 2026/0061714 A1
(43) Pub. Date: Mar. 5, 2026

(54) Tube Roller Clamp

(71) Applicant: Carolina Components Group, Inc., Durham, NC (US)

(72) Inventors: Lawrence George Morano, III, Raleigh, NC (US); Andrew Joseph Witters, Morrisville, NC (US); Andrew Neal Gilje, Durham, NC (US); Mark Christopher McElligott, Windham, NH (US)

(21) Appl. No.: 19/275,765

(22) Filed: Jul. 21, 2025

Related U.S. Application Data
(63) Continuation of application No. PCT/US2024/044491, filed on Aug. 29, 2024.

(51) Int. Cl. B30B 3/00; B30B 9/20

(52) U.S. Cl. CPC B30B 3/005; B30B 9/20

(57) ABSTRACT

A first section and a second section for forming a tube roller clamp for evacuating fluid from flexible tubing in a single flow direction. The sections each having: a roller for contact with the flexible tubing; and a pair of spacing clips for holding the roller (300) in a fixed position relative to a housing portion. The roller is constrained by the spacing clips from movement perpendicular to the longitudinal axis of the roller but is able to rotate around the longitudinal axis (190). Also disclosed are methods for using the tube roller clamp and methods for making a family of tube roller clamps adapted for different types of flexible tubing.

This application claims priority to co-pending PCT Application No. PCT/US2024/044491 filed Aug. 24, 2024 with the title Tube Roller Clamp. The '491 application is incorporated by reference in its entirety.

### BACKGROUND

### Field of the Disclosure

This disclosure relates generally to tools used with flexible tubing to remove valuable fluid that is left in the flexible tubing after the completion of a process. Removal of the fluid may be called stripping or evacuation. More specifically, a device to directionally displace and clear process fluid left in flexible tubing during or at the completion of unit operations where hold-up volume is a quality or business risk. This class of tools is often called a stripper clamp. The phrase stripper clamp notes that the stripper clamp may be left in place where it serves as a clamp to prevent fluid from passing back through the clamp in the opposite flow direction from the direction of flow that the stripper clamp was moving. The stripper clamp may be designed so that the stripper clamp can only move in one direction along the flexible tubing. Another descriptive name is a tube roller clamp and that name will be used for the devices suggested by disclosure.

### Related Art

The concept of a stripper clamp that is used to selectively push residual fluid out of flexible tubing is not new. An example of this concept is U.S. Pat. No. 4,266,751 for a stripper clamp. This particular stripper clamp is intended for use removing blood from flexible tubing in order to maximize a donation of blood. United States Patent Application Publication US 2013/0108492 described an Integrated Blood Donor Tube Stripper and Crimping Apparatus. Both the '751 and the '492 teach a hand tool that is meant to be used repeatedly by a cleanroom operator. The tools are not adapted for being left in place as a clamp for any length of time as the weight of the tools would tend to pull on the tubing. Further, the designs appear to require machining of a variety of metal parts in order to assemble the device. Finally, the '751 appears to require that the tubing be threaded through the device through opening 15 and opening 16. In the context of use for manufacturing pharmaceuticals, this would seem to require either A) that a stripper device be placed on the tubing as the pharmaceutical manufacturing line is set up so that the stripper device is threaded onto the tubing when it becomes necessary to recover fluid at the end of use of a particular setup, or B) that tubing will need to be disconnected and threaded through a stripper device while holding fluid thus risking loss of the fluid or contamination of the fluid.

Neither the '751 nor the '492 teach a design that lends itself to plastic injection molding or produces a device that can be left in place to clamp the tubing without a user supporting the weight of the device.

### Vocabulary

### A, An.

In this application, and the claims that follow, the terms a, an, or the identification of a single thing should be read as at least one unless such an interpretation is impossible within the context of the entirety of the specification. For example, the use of the terms sole, only, or the phrase not more than one would indicate that a single item is intended.

### Gne and Gnes.

To avoid the awkward he/she and his/her or the potentially confusing singular use of they and their, this application uses the Gender-Neutral Expression—gne, the possessive pronoun—gnes, reflexive pronoun—gneself and the object form—gnerm. Example—Gne looked for gnes notebook gneself as gnes friends would not help gnerm.

### Or.

Unless explicit to the contrary, the word “or” should be interpreted as an inclusive or rather than an exclusive or. Thus, the default meaning of or should be the same as the more awkward and/or.

### Set.

Unless explicit to the contrary, the word “set” should be interpreted as a group of one or more items.

### Step.

The term step may be used in descriptions within this disclosure. For purposes of clarity, one distinct act or step may be discussed before beginning the discussion of another distinct act or step. The term step should not be interpreted as implying any particular order among or between various steps disclosed unless the specific order of individual steps is expressly indicated.

### Substantially.

Frequently, when describing an industrial process it is useful to note that a given parameter is substantially met. Examples may be substantially parallel, substantially perpendicular, substantially uniform, and substantially flat. In this context, substantially X means that for purposes of this industrial process it is X. So something that may not be absolutely parallel but is for all practical purposes parallel, is substantially parallel. Likewise, mixed air that has substantially uniform temperature would have temperature deviations that were inconsequential for that industrial process.

As recognized in C. E. Equipment Co. v. United States, 13 U.S.P.Q.2d 1363, 1368 (Cl. Ct. 1989), the word “substantially” in patent claims gives rise to some definitional leeway—thus the word “substantially” may prevent avoidance of infringement by minor changes that do not affect the results sought to be accomplished.

In this application, there are teachings that the roller shafts cannot move laterally with respect to a longitudinal centerline. This is true as there cannot be any substantial lateral movement but one of skill in the art will recognize that in order to allow free rotation there has to be some difference between the relevant outer diameters and inner diameters. This minute difference will allow some theoretical and de minimis movement but that does not mean that in any practical way that the shafts can move laterally with respect to a longitudinal centerline.

### SUMMARY OF THE DISCLOSURE

Aspects of the teachings contained within this disclosure are addressed in the claims submitted with this application upon filing. Rather than adding redundant restatements of the contents of the claims, these claims should be considered incorporated by reference into this summary.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Inventive concepts are illustrated in a series of examples, some examples showing more than one inventive concept. Individual inventive concepts can be implemented without implementing all details provided in a particular example. It is not necessary to provide examples of every possible combination of the inventive concepts provided below as one of skill in the art will recognize that inventive concepts illustrated in various examples can be combined together in order to address a specific application.

Some aspects of the teachings of the present disclosure may be expressed as a first section 170 and a second section 180 for forming a tube roller clamp 100 for evacuating fluid from flexible tubing 900 in a single flow direction, the first section 170 and the second section 180 each having:
a roller 300, 380 having a longitudinal axis 190 partially surrounded by a roller body 330 for contact with the flexible tubing 900;
a pair of spacing clips 400, 450 for holding the roller 300 in a fixed position relative to an outer face 290 of a housing portion 200;
such that the roller 300 is constrained by the spacing clips 400, 450 from movement perpendicular to the longitudinal axis 190 but is able to rotate around the longitudinal axis 190.

The first section 170 is adapted to reversibly connect to the second section 180 after inversion to allow an end user to assemble the tube roller clamp 100 for evacuating fluid by capturing flexible tubing 900 between rollers 300, 380.

Other aspects of the teachings of the present disclosure may be expressed as a kit for creating a tube roller clamp 100 for evacuating fluid from flexible tubing, the kit containing:
a first section 170; and
a second section 180; wherein the first section 170 is adapted for reversible connection with the second section 180.

Each of the first section 170 and the second section 180 having:
a roller 300, 380 with a roller body 330 in an intermediate section of the roller 300;
a pair of spacing clips 400, 450 adapted to engage the roller at both a first end of a roller shaft 304 or a second end of the roller shaft 304 to allow the roller 300, 380 to rotate around a longitudinal axis 190 of the roller 300, 380 but not move a substantial amount laterally relative to the longitudinal axis 190; and
the pair of spacing clips 400 with the engaged roller 300 attached to a housing portion 200 so that the longitudinal axis 190 of the roller 300 is a specific placement within the housing portion 200 so that when the first section 170 is reversibly connected to the second section 180 by an end user, a gap 350 between the pair of roller bodies 330 is appropriate to squeeze a particular type of flexible tubing 900 to evacuate fluid from the flexible tubing 900.

Additional aspects of the teachings of the present disclosure may be expressed as a process for creating a kit for a tube roller clamp 100 for evacuating fluid from flexible tubing, the process including:
placing a first journal 310 of a first roller 300 in a first spacing clip 400;
placing a second journal 310 of the first roller 300 in a second spacing clip 400;
inserting the first spacing clip 400 and the second spacing clip 400 into a first housing portion 200 to form a first section 170 and placing the first roller 300 in a fixed relationship with the first housing portion 200;
placing a third journal 310 of a second roller 300 in a fourth spacing clip 400;
placing a fourth journal 310 of the second roller 300 in a fourth spacing clip 400;
inserting the third spacing clip 400 and the fourth spacing clip 400 into a second housing portion 200 to form a second section 180 and placing the second roller 300 in a fixed relationship with the second housing portion 200.

The tube roller clamp 100 to be formed by a user that connects to the first section 170 to the second section 180 will have a gap 350 between the first roller 300 and the second roller 300 that is appropriate to create a squeezed portion of a particular type of flexible tubing to be placed between the first roller 300 and the second roller 300.

Yet other aspects of the teachings of the present disclosure may be expressed as a process for evacuating fluid from flexible tubing using a tube roller clamp 100 including:
obtaining a first section 170 of a tube roller clamp 100;
obtaining a second section 180 of the tube roller clamp 100;
placing the flexible tubing between the first section 170 and the second section 180 before engaging the first section 170 with the second section 180 to form a complete tube roller clamp 100 and to create a squeezed portion of the flexible tubing between a first roller 300 and a second roller 300; and
moving the tube roller clamp 100 in a first direction of movement relative to the flexible tubing to move the squeezed portion of the flexible tubing and evacuate any fluid in the flexible tubing in the first direction of movement.

Yet another aspect of the teachings of the present disclosure may be expressed as a process for creating a first kit for a first tube roller clamp 100 adapted for use with a first type of flexible tubing 900 having a first wall thickness 904 and then creating a second kit for a second tube roller clamp 100 adapted for use with a second type of flexible tubing 900 having a second wall thickness 904 that is different from the first wall thickness 904; this process having the steps of:
obtaining four identical housing portions 200, with an outer face 290 between a top end of the housing portion and a bottom end of the housing portion;
obtaining four identical rollers 300, 380 having roller bodies 330 between a pair of ends;
obtaining a first set of two spacing clips 400, 450 adapted so that the first set of two spacing clips places a longitudinal axis 190 of a first roller 300, 380 a first known distance from a first outer face 290 of a first housing portion 200;
using the first set of spacing clips 400, 450 to attach a first roller 300, 380 to a first housing portion 200;
obtaining a second set of two spacing clips 400, 450 adapted so that the second set of two spacing clips places a longitudinal axis 190 of a second roller 300, 380 a second known distance of a longitudinal axis 190 from a second outer face 290 of a second housing portion 200;
using the second set of two spacing clips 400, 450 to attach a second roller 300, 380 to a second housing portion 200;
obtaining a third set of two spacing clips 400, 450 adapted so that the third set of two spacing clips places a longitudinal axis 190 of a third roller 300, 380 a third known distance of a longitudinal axis 190 of the third roller 300, 380 from a third outer face 290 of a third housing portion 200;
using the third set of spacing clips 400, 450 to attach a third roller 300, 380 to the third housing portion 200;
obtaining a fourth set of spacing clips 400, 450 adapted so that the fourth set of two spacing clips places a longitudinal axis 190 of a fourth roller 300, 380 a fourth known distance of the longitudinal axis 190 of the fourth roller 300 from the fourth outer face 290 of the fourth housing portion 200;
using the fourth set of two spacing clips 400, 450 to attach a fourth roller 300, 380 to the fourth housing portion 200.

In this process, a sum of the first known distance plus the second known distance does not equal a sum of the third known distance and the fourth known distance and thus a tube roller clamp 100 made using the first set of spacing clips 400, 450 and the second set of spacing clips 400, 450 would have a first gap 350 between rollers 300, 380 that is suitable for a first type of flexible tubing 900 having a first wall thickness 904 and a tube roller clamp 100 made using the third set of spacing clips 400, 450 and the fourth set of spacing clips 400, 450 would have a second gap 350 between rollers 300, 380 that is suitable for a second type of flexible tubing 900 having a second wall thickness 904 that is different from the first wall thickness 904.

An additional aspect of the teachings of the present disclosure may be expressed as a process for creating a first kit for a first tube roller clamp 100 adapted for use with a first type of flexible tubing 900 having a first wall thickness 904 and then creating a second kit for a second tube roller clamp 100 adapted for use with a second type of flexible tubing 900 having a second wall thickness 904 that is different from the first wall thickness 904; the process including the steps of:
obtaining four identical housing portions 200, with an outer face 290 between a top end of the housing portion and a bottom end of the housing portion;
obtaining eight identical spacing clips 400, 450;
obtaining four rollers 300, 380;
using a first set of spacing clips 400, 450 to attach a first roller 300, 380 to a first housing portion 200;
using a second set of two spacing clips 400, 450 to attach the second roller 300, 380 to a second housing portion 200;
using a third set of spacing clips 400, 450 to attach a third roller 300, 380 to the third housing portion 200;
using a fourth set of two spacing clips 400, 450 to attach a fourth roller 300, 380 to the fourth housing portion 200; and

The process producing both:
a tube roller clamp 100 made from the first kit that uses the first roller 300, 380 and the second roller 300, 380 results in the first tube roller clamp 100 having a gap 350 between the first rollers 300, 380 and the second roller 300, 380 that is suitable for a first type of flexible tubing 900 having a first wall thickness 904; and
a tube roller clamp 100 made from the second kit using the third set of spacing clips 400, 450 and the fourth set of spacing clips 400, 450 would have a gap 350 between rollers 300, 380 that is suitable for a second type of flexible tubing 900 having a second wall thickness 904 that is different from the first wall thickness 904.

An additional aspect of the teachings of the present disclosure may be expressed as a process for creating a first kit for a first tube roller clamp 100 adapted for use with a first type of flexible tubing 900 having a first wall thickness 904 and then creating a second kit for a second tube roller clamp 100 adapted for use with a second type of flexible tubing 900 having a second wall thickness 904 that is different from the first wall thickness 904, the process having the steps of:
obtaining four housing portions 200, with an outer face 290 between a top end of the housing portion and a bottom end of the housing portion;
obtaining eight identical spacing clips 400, 450;
obtaining four identical rollers 300, 380;
using a first set of spacing clips 400, 450 to attach a first roller 300, 380 to a first housing portion 200;
using a second set of two spacing clips 400, 450 to attach the second roller 300, 380 to a second housing portion 200;
using a third set of two spacing clips 400, 450 to attach a third roller 300, 380 to a third housing portion 200;
using a fourth set of two spacing clips 400, 450 to attach a fourth roller 300, 380 to a fourth housing portion 200; and

The process resulting in a tube roller clamp 100 made from the first kit that uses the first housing portion 200 and the second housing portion 200 results in the first tube roller clamp 100 having a gap 350 between the first rollers 300, 380 and the second roller 300, 380 that is suitable for a first type of flexible tubing 900 having a first wall thickness 904 and a tube roller clamp 100 made from the second kit using the third housing portion 200 and the fourth housing portion 200, and a second gap 350 between rollers 300, 380 that is suitable for a second type of flexible tubing 900 having a second wall thickness 904 that is different from the first wall thickness 904.

Other systems, methods, features and advantages of the disclosed teachings will be immediately apparent or will become apparent to one with skill in the art upon examination of the following figures and detailed description. It is intended that all such additional systems, methods, features and advantages be included within the scope of and be protected by the accompanying claims.

### BRIEF DESCRIPTION OF THE FIGURES

The disclosure can be better understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 introduces the tube roller clamp 100.

FIG. 2 shows the tube roller clamp 100 before the two sections 104 are connected to one another.

FIG. 3 is an exploded drawing of the components in tube roller clamp 100.

FIG. 4 shows a cross section of the tube roller clamp 100 from FIG. 1 with the first section 170 and the second section 180 connected together.

FIG. 5 shows two views of rollers 300.

FIG. 6 shows a pair of rollers 300 with each roller 300 positioned within a pair of spacing clips 400.

FIG. 7 shows two different spacing clips 400.

FIG. 8 shows the components from FIG. 6 plus a housing portion 200.

FIG. 9 shows two tube roller clamps 100 with a first tube roller clamp 102 and a second tube roller clamp 106.

FIG. 10 shows the first section 170 of the tube roller clamp 100.

FIG. 11 is a cross section of FIG. 9 taken just above the first ratchet wheel 320.

FIG. 12 is a flow chart for a process 1000 for use of a tube roller clamp 100 as taught within this disclosure.

FIG. 13 is a flow chart for a process 2000 for creating a kit for a first tube roller clamp adapted for use with a first type of flexible tubing 900 having a first wall thickness and then creating a kit for a second tube roller clamp adapted for use with a second type of flexible tubing 900 having a second wall thickness that is different from the first wall thickness.

FIG. 14 is a top, front, right perspective view of the exterior of the tube roller clamp 100.

FIG. 15 is a top, rear, right perspective view of the exterior of the tube roller clamp 100.

FIG. 16 is a top, rear, left perspective view of the exterior of the tube roller clamp 100.

FIG. 17 is a top, front, left perspective view of the exterior of the tube roller clamp 100.

FIG. 18 is a bottom, front, right perspective view of the exterior of the tube roller clamp 100.

FIG. 19 is a bottom, rear, left perspective view of the exterior of the tube roller clamp 100.

FIG. 20 is a left elevation view of the exterior of the tube roller clamp 100.

FIG. 21 is a right elevation view of the exterior of the tube roller clamp 100.

FIG. 22 is a front elevation view of the exterior of the tube roller clamp 100.

FIG. 23 is a rear elevation view of the exterior of the tube roller clamp 100.

FIG. 24 is a top plan view of the exterior of the tube roller clamp 100.

FIG. 25 is a bottom plan view of the exterior of the tube roller clamp 100.

FIG. 26 shows a cross-section of a pair of alternative spacing clips 450 and an alternative roller 300.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The assembly shown in the next series of drawings is a unidirectional stripping device that may also serve as a clamp. A device in accordance with the teachings of the present disclosure may be used to facilitate the conveyance and retention of materials at an intended destination for the purposes of product recovery and retention. Thus after the completion of processing a liquid, such as processing pharmaceutical chemicals or their various precursors, the liquid that is still in a segment of flexible tubing can be evacuated into a reservoir or other container that is downstream. Thus, the valuable liquid in the flexible tubing becomes part of the process yield rather than wasted when the tubing is disposed of. Fluid that is left in tubing or other process devices and disposed of rather than collected is often known as “hold-up volume”. The use of stripper assemblies in accordance with this disclosure will help reduce the undesired hold-up volume.

Pharmaceutical manufacturing methods have previously attempted to remove liquid left in flexible tubing to a downstream intended location through use of conventional methods such as disconnecting the upstream end of the flexible tubing and raising the tubing to allow fluid to drain out at the downstream end.

The process of draining the tubing could employ compressed air to help drain a line of a valuable fluid. The compressed air would need to be exceptionally clean in order to avoid contaminating the fluid within the flexible tubing. Sometimes this fluid is exceptionally valuable as it is a pharmaceutical that is valuable at the milliliter level. Sometimes the fluid is of lower value per unit volume such as a buffer or media used in the production process but worthy of the effort to collect. The use of compressed air requires at least:
a source of compressed air from either a mobile compressor or from a connection to a compressed air supply;
a way to quickly connect the compressed air to the upstream tubing;
a pressure regulator; and
a power source if the compressed air is provided by a mobile compressor.

As it is critical that the fluid not be contaminated by foreign matter any, such process to disconnect both ends of the tubing and have someone apply compressed air at a first end to blow out the tubing at a second end may require two people for a tube that does not stop and end close to itself.

Further, even the cleanest of air or another gas that comes into contact with process material can change the physical state by impacting pH, degassing, creating shear, or other changes. These undesired state changes can all be avoided using this tubing roller. In other words, while a process of blowing out the tubing using compressed air is possible, many may wish for another option.

The cleanroom manufacturing technicians (“operators”) often execute the series of tasks needed in order to manufacture pharmaceuticals or other high value liquids within a cleanroom. A cleanroom is a special space that is designed to have a very low concentration of airborne particles that might contaminate the items being produced. Beyond the detailed engineering of the room, the cleanroom manufacturing technicians (“cleanroom operators”) in the cleanroom are fully covered so that the cleanroom operators do not shed skin cells or hair into the air. The relevance to the present application is that the cleanroom operators in a cleanroom will have undergone cleanroom gowning and will be wearing one, often two pairs of cleanroom gloves such as gloves made of nitrile rubber. Any tools intended for use by gloved cleanroom operator needs to be something that can be manipulated easily by a gloved cleanroom operator.

### Tube Roller Clamp Assembly.

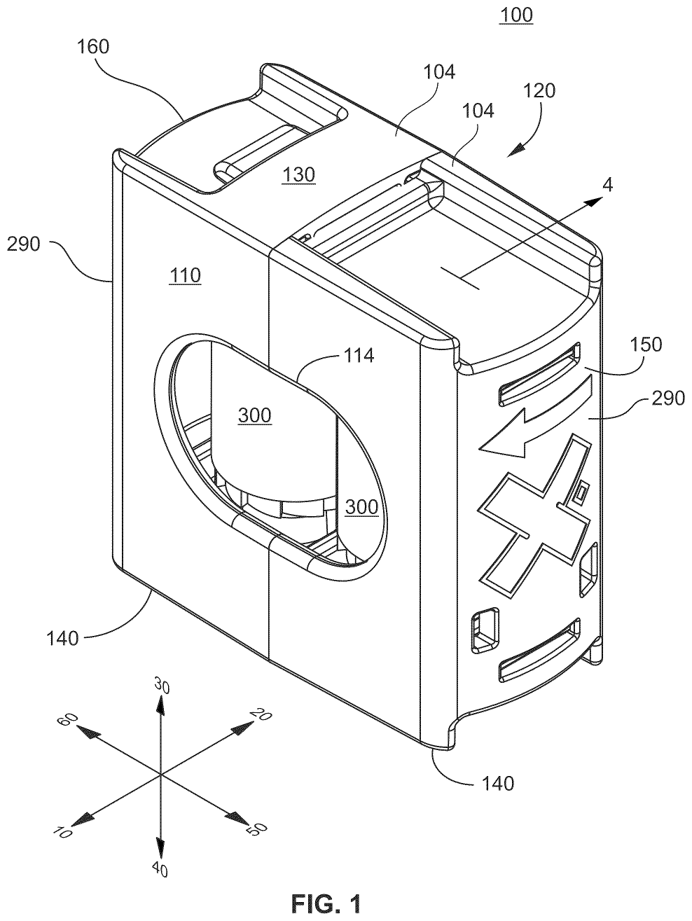

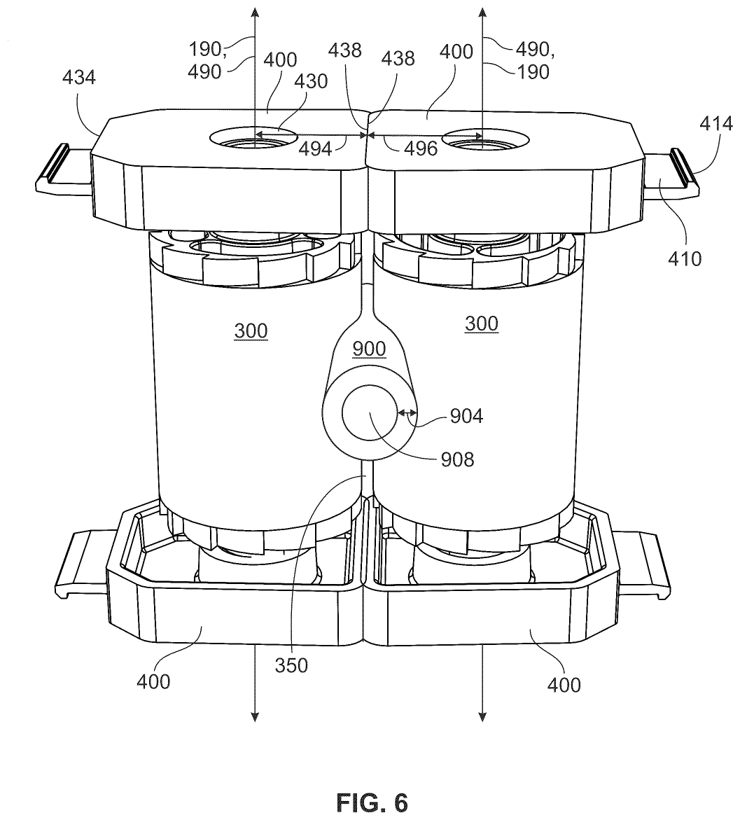

FIG. 1 introduces the tube roller clamp 100. FIG. 1 is a top, front, right perspective view of the tube roller clamp 100. FIG. 1 includes three axes in order to allow for discussion of directions. Front 10 is defined as the direction that the tube roller clamp 100 moves to push stripped fluid from the captured flexible tubing 900 (See FIG. 6). Conversely, back 20 is the opposite side of the tube roller clamp 100. A vertical axis is shown with up 30 and down 40. The left/right axis is shown with left 60 and right 50. Note that in operation, the tube roller clamp 100 may be rotated around the up/down and left/right axis. In other words the tube roller clamp 100 may be rotated in any position around the longitudinal axis if the flexible tubing 900 passes through the tube roller clamp 100. But having axes can be helpful when describing components.

In harmony with the previously defined axes, the tube roller clamp 100 has a front side 110, a back side 120, a top side 130, a bottom side 140, a right side 150, and a left side 160.

In stark contrast to the Stripper Clamp described in U.S. Pat. No. 4,266,751 discussed above, flexible tubing 900 is not threaded through the tube roller clamp 100, but rather the two sections 104 of the tube roller clamp are placed on either side of the flexible tubing 900 before snapping the two sections 104 together to form the tube roller clamp 100 and capture the flexible tubing 900 by the tube roller clamp 100. A front window 114 and a corresponding back window 124 allow the tube roller clamp 100 to be assembled around the flexible tubing 900. As can be seen through the front window 114, there are a pair of rollers 300 that are spaced close enough to one another to compress the flexible tubing 900 and strip fluid from the flexible tubing 900 as the rollers 300 roll over the flexible tubing 900.

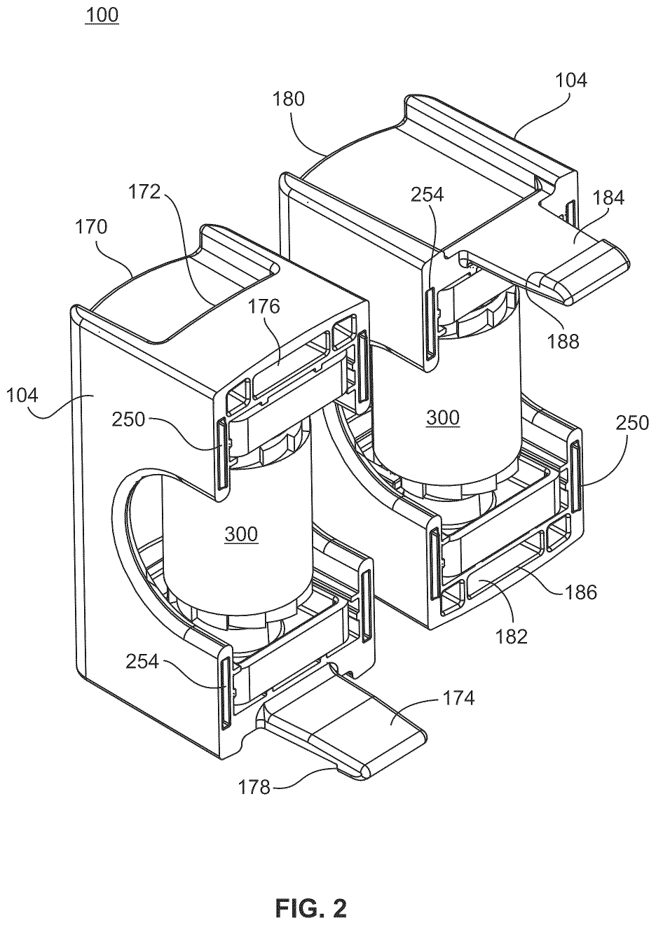

### FIG. 2.

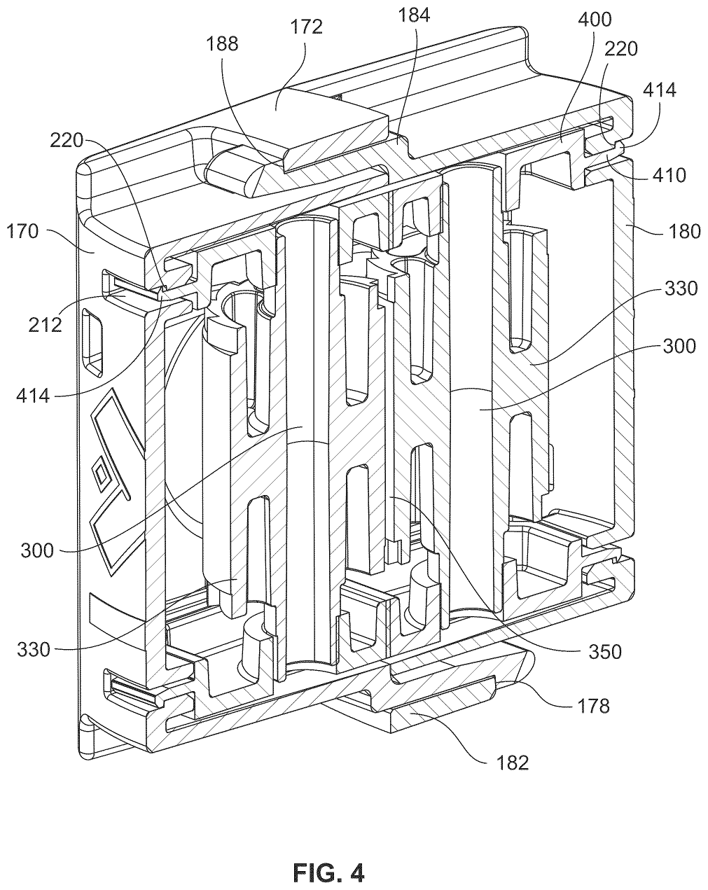

FIG. 2 shows the tube roller clamp 100 before the two sections 104 are connected to one another. In a preferred embodiment, the tube roller clamp 100 is made by connecting two identical sections 104. Thus, a first section 170 is identical to a second section 180. By having one section 104 inverted relative to the other section 104, first section 170 with housing tab 174 can be inserted into an opening 186 in the second section 180 while housing tab 184 of the second section 180 is inserted into an opening 176 in the first section 170. Housing tab 174 has a retention face 178 that reversibly engages with a retention bar 182 (See also FIG. 4) beyond opening 186 in second section 180. Likewise, housing tab 184 has a retention face 188 that reversibly engages with the retention bar 172 beyond opening 176 in first section 170.

FIG. 2 also shows optional stabilizer ridges 250 and stabilizer gaps 254 to receive the stabilizer ridges 250. The use of the stabilizer ridges 250 and stabilizer gaps 254 adds another measure of stability to the interaction between the two engaged housing portions 200.

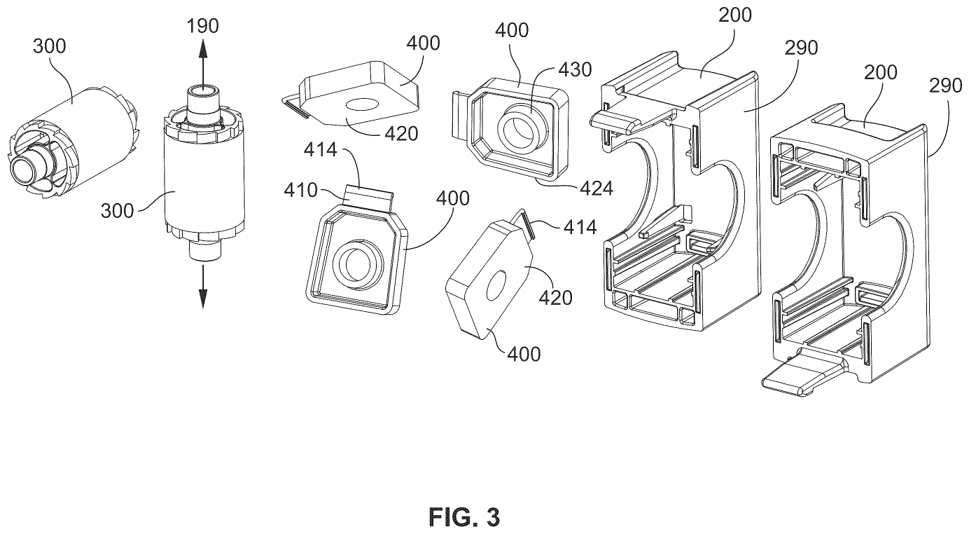

### FIG. 3.

FIG. 3 is an exploded drawing of the components in tube roller clamp 100. In a preferred embodiment, there are only three distinct component types and a total of only eight components. More specifically a tube roller clamp 100 is made from:
Two housing portions 200;
Two rollers 300; and
Four spacing clips 400.

These eight components are assembled to form two identical sections 104 which are then connected to one another while capturing an appropriate type of flexible tubing 900 between the two rollers 300 to compress the flexible tubing 900 and allow for evacuation of retained fluid from the flexible tubing 900.

Each section 104 has one housing portion 200, one roller 300, and two spacing clips 400. To assemble, a pair of spacing clips 400 are placed on opposite ends of the roller 300 before engaging the spacing clips 400 with the housing portion 200 so that the roller 300 is now attached to a housing portion 200 and constrained from moving radially in any direction perpendicular to a longitudinal axis 190 of the roller 300. The captured roller 300 has a bit of space within the pair of engaged spacing clips 400 so that the captured roller 300 is free to rotate relative to the housing portion 200. However, as described in detail below, the rollers 300 are precluded from rotating in one direction, but allowed to rotate in the other direction. This constraint of the roller rotation makes the tube roller clamp 100 a unidirectional tool that can only move in one direction with respect to the center axis of the flexible tubing 900.

As described in more detail below, a single mold to make housing portions 200 and a single mold to make rollers 300 can be used to make a family of tube roller clamps 100 adapted for use against a family of flexible tubing 900 types as changing the spacing clip 400 used in the stripper moves the longitudinal axis 190 of the roller 300 relative to an outer face 290 of the housing portion 200. Use of spacing clips 400 that move longitudinal axis 190 of the roller 300 closer to the outer face 290 of the housing portion 200 would adapt the tube roller clamp to work with flexible tubing 900 having thicker walls. Conversely, use of spacing clips 400 that move longitudinal axis 190 of the roller 300 further from the outer face 290 of the housing portion 200 would adapt the tube roller clamp to work with flexible tubing 900 with a thinner wall thickness 904. One of skill in the art will appreciate that changing the spacing clips 400 within only one of the two housing portions 200 would result in half of the change of distance between rollers than making the same change of spacing clips 400 in both housing portions 200.

Each spacing clip 400 has a top face 420, a clip tab 410 with a tab ridge 414, and a lower perimeter 424. The clip tab 410 and the tab ridge 414 interact with the housing portion 200 to hold a pair of spacing clips 400 and a trapped roller 300 to a housing portion 200. Each spacing clip 400 has a bushing 430 to receive a journal 310 of a roller 300.

### Cross Section.

FIG. 4 shows a cross section of the tube roller clamp 100 from FIG. 1 with the first section 170 and second section 180 (See FIG. 2) connected together. Visible in this figure is the interaction between the retention face 188 of the housing tab 184 of the second section 180 with the retention bar 172 of the first section 170. Likewise, the interaction of the tab ridge 414 of the clip tab 410 of the spacing clip 400 with the retention face 220 within tab slot 212 to hold the four spacing clips 400 to the two housing portions 200. The four spacing clips 400 hold the two rollers 300 to create a desired gap 350 between roller bodies 330. Visible in this cross section is an interaction between retention bar 182 and retention face 178.

Aside—A careful observer may note a small gap between the tab ridge 414 and the retention face 220. This small gap is an imperfection in the CAD model rather than an actual gap.

### Rollers.

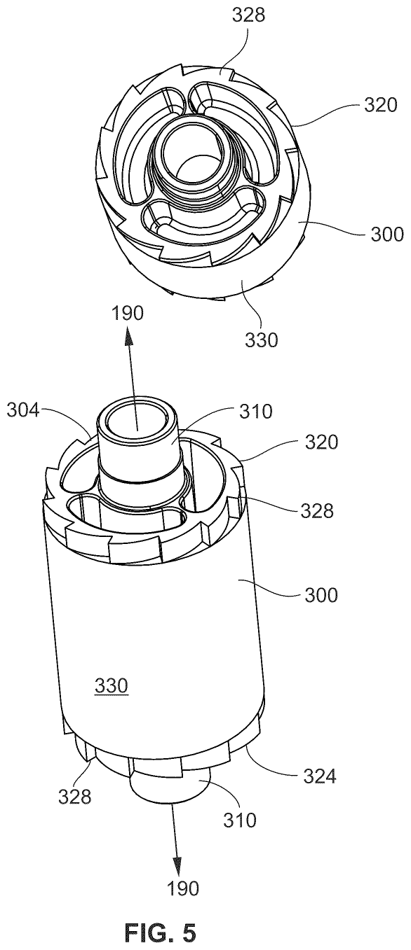

FIG. 5 shows two views of rollers 300. Each roller 300 has a longitudinal axis 190 of the roller 300. The rollers have a roller body 330 that is used to press against the flexible tubing 900. The roller 300 has a roller shaft 304 that runs from one end of the roller 300 to the other end. At each end of the roller shaft 304, a portion of the roller shaft 304 can be deemed the journal 310, as this surface forms a bearing surface with a portion of the spacing clip 400. Between the roller body 330 and the journal 310 there is a first ratchet wheel 320 and a second ratchet wheel 324 with each having ratchet teeth 328. The ratchet teeth 328 interact with portions of the housing portion 200 as described in more detail below. This interaction precludes substantial rotation of the roller 300 in one direction, but allows rotation in the other direction. These rollers 300 allow the top end of the roller 300 to rotate counter-clockwise as viewed from the top. This would be clockwise as viewed from the bottom. One of skill in the art will recognize that while first ratchet wheel 320 and second ratchet wheel 324 when viewed from the side would alternatively block clockwise motion as viewed from the top and counter-clockwise motion as viewed from the bottom, the roller 300 ratchet wheel 320 and ratchet wheel 324 are actually the same as no matter which way one orients the roller 300, the top ratchet wheel precludes motion in the same direction. In this case, clockwise as looking down at the ratchet wheel 320 when on top of the roller 300 or looking down on ratchet wheel 324 when the roller 300 is flipped so that ratchet wheel 324 is on top.

### Roller Spacing.

FIG. 6 shows a pair of rollers 300 with each roller 300 positioned within a pair of spacing clips 400. This figure was created by taking a CAD image of an assembled tube roller clamp 100 and making both housing portions 200 invisible. Thus, one can see the relative positions of the rollers 300 for a given choice for spacing clips 400. Moving the bushing 430 of the spacing clip 400 relative to the outer face 434 and the inner face 438 changes the position of the longitudinal axis 190 of the roller 300 relative to the longitudinal axis 190 of the other roller 300 as the position of the spacing clip 400 is fixed relative to the housing portion 200 via the interaction of the clip tab 410 and tab ridge 414 with the housing portion 200. Thus, if one keeps the housing portions 200 and the rollers 300 constant, one can alter the gap 350 between roller bodies 330 by altering the selection of spacing clips 400.

As the rollers 300 are constrained from lateral movement by the spacing clips 400, the longitudinal axis 190 of the rollers 300 is essentially also the centerline 490 of the bushing 430. One of skill in the art will know that the outer diameters of the journals 310 will be slightly less than the inner diameters of the bushings 430 so some small lateral movement of the journal 310 in the bushing 430 would be possible, but will ignore that minor difference for purposes of this explanation.

For example, for one embodiment, the bushing 430 has in interior diameter of 0.386 inches while the outer diameter of the roller journal is 0.374 inches. Thus, the roller 300 is substantially constrained from lateral movement relative to the longitudinal axis 190 but is not absolutely constrained. Absolute lateral constraint would require having an interior diameter for the bushing 430 to be equal or less than the outer diameter of the roller journals 310. Absolute lateral constraint would be unacceptable as the ability of the roller 300 to rotate around the longitudinal axis would be precluded or require unusual amounts of force.

As the inner face 438 of one spacing clip 400 abuts the inner face 438 of the other spacing clip 400, the gap 350 between roller bodies 330 will be knowable for a roller 300 with a roller body 330 of a particular diameter based on the combination of a first distance 494 between an inner face 438 of a first spacing clip 400 and the centerline 490 of the bushing 430 and the second distance 496 between an inner face 438 of the second spacing clip 400 and the centerline 490 of the bushing 430. If the two spacing clips are identical, the first distance 494 will be the same as the second distance 496. But this is not required as the first distance 494 may be different than the second distance 496.

FIG. 6 shows flexible tubing 900 with an open tubing interior 908 surrounded by walls with a wall thickness 904. The gap 350 between roller bodies 330 is selected so that the flexible tubing 900 is compressed to eliminate any open tubing interior 908. In many instances the gap 350 will be sized less than twice the uncompressed thickness of the wall thickness 904 so that the walls of the flexible tubing 900 are compressed.

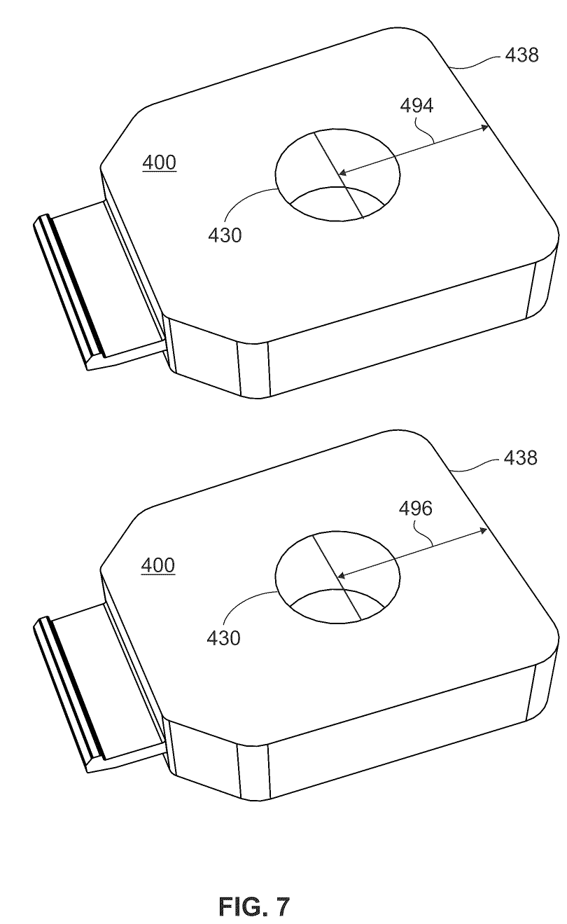

### FIG. 7.

FIG. 7 shows two different spacing clips 400. The spacing clips 400 differ only in the distance of the center of the bushing 430 to the inner face 438. The first distance 494 is larger than the second distance 496. A tube roller clamp 100 using a set of spacing clips 400 having the first distance 494 would be used with flexible tubing 900 having a large wall thickness “A”. Conversely, a tube roller clamp 100 using a set of spacing clips 400 with the second distance 496 would be tuned for use with flexible tubing 900 having a wall thickness “B” where “B” is significantly less than “A”.

Returning to FIG. 6, one of skill in the art would understand that to strip flexible tubing 900 having a wall thickness 904 of 0.063 inches, a first gap 350 would be appropriate. For flexible tubing 900 having wall thicknesses 904 that are thicker than 0.063 inches, other gaps 350 would be appropriate. Altering first distance 494 and second distance 496 allows the tube roller clamp 100 to have the appropriate gap 350 for different flexible tubes with different wall thicknesses. Wall thicknesses of 0.188 inches or greater are used for various flexible tubing 900 walls.

For one type of flexible tubing 900 made of Platinum Cured Silicone/Thermoplastic Elastomer, a gap 350 that is equal to 80% of twice the tubing wall thickness has been found effective. Thus for a tubing wall thickness of 0.063 inches a suitable gap 350 would be approximately 0.8×(2×0.063 inches) which would be in the range of 0.101 inches. Those of skill in the art will appreciate that using 85% instead of 80% would decrease the resistance in advancing the tube roller clamp 100 but at the risk of possibly increasing the liquid that is not removed from the flexible tubing 900. Conversely, using 75% instead of 80% would decrease the risk of liquid that is not stripped out of the tubing at the cost of having to expend more force to advance the tube roller clamp 100 along the flexible tubing 900. The use of a material for making the tubing that is easily compressible may allow for a smaller gap versus tubing with the same wall thickness that is made of a material that is difficult to compress.

Note that the inner diameter of the flexible tubing 900 and the outer diameter of the flexible tubing 900 is not relevant to the choice of gap 350. The gap 350 is a function of the wall thickness of the flexible tubing and possibly the compressibility of the flexible tubing 900. A second factor that impacts the choice of optimal gap 350 is the tubing durometer as some flexible tubing 900 is less compressible than other flexible tubing 900 with the same wall thickness.

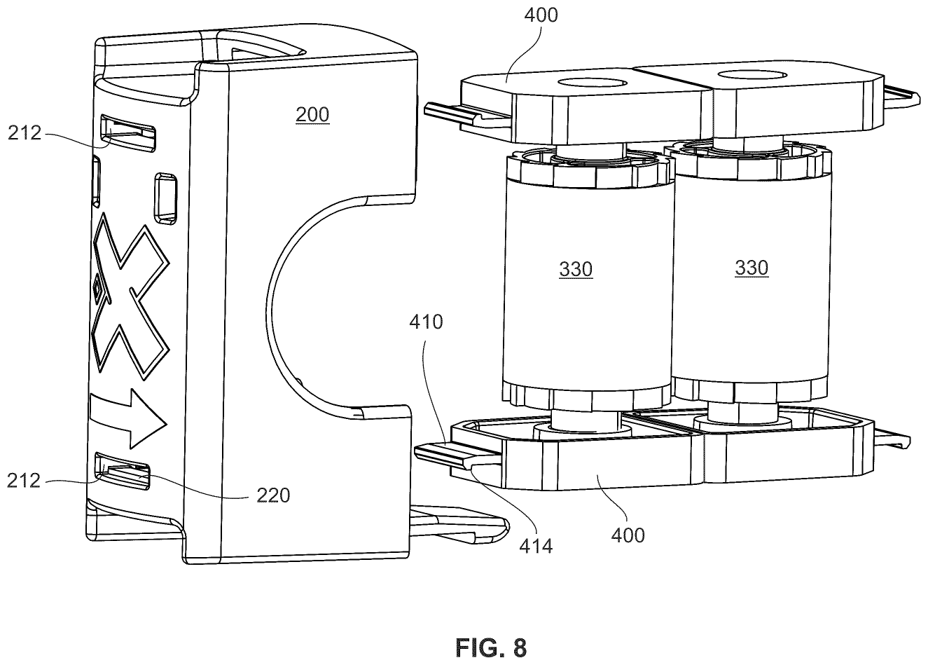

### FIG. 8.

FIG. 8 shows the components from FIG. 6 plus a housing portion 200. One can see that housing portion 200 has a pair of tab slots 212 with retention faces 220 to receive and capture clip tabs 410 so that the tab ridge 414 rests against retention face 220. This interaction is achieved during factory assembly of tube roller clamp 100 and does not need to be easily reversible as end users are not likely to want to change out spacing clips 400 as the end user would have purchased a tube roller clamp 100 tuned for a particular wall thickness of flexible tubing 900 so that the spacing clips 400 in use provide an appropriate gap 350 (FIG. 6) between roller bodies 330 to strip fluid from the flexible tubing 900.

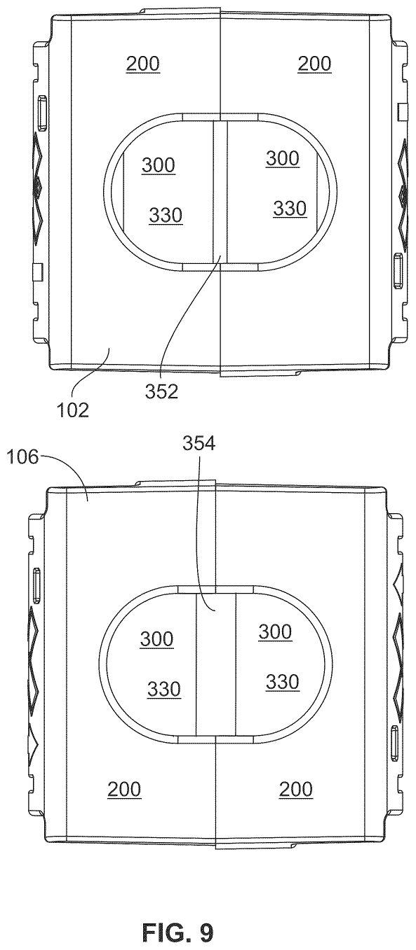

### FIG. 9.

FIG. 9 shows two tube roller clamps 100 with a first tube roller clamp 102 and a second tube roller clamp 106. The two tube roller clamps (102 and 106) each have two rollers 300 and all four rollers 300 are identical. The two tube roller clamps (102 and 106) each have two housing portions 200 and all four housing portions 200 are identical. The gap 352 between two adjacent roller bodies 330 in tube roller clamp 102 is much smaller than the gap 354 between the two adjacent roller bodies 330 in tube roller clamp 106. The difference in the gaps (352 versus 354) is due to differences in the spacing clips 400 used in tube roller clamp 102 and tube roller clamp 106.

As a preferred design uses the same housing portion 200 and the same roller 300 across the entire range of flexible tube wall thicknesses, a convenient way for a cleanroom operator to confirm the intended flexible tube type for a tube roller clamp 100 to be formed from two sections 104 (see FIG. 2) is to color code the spacing clips 400. The tab ridge 414 (see FIG. 6) of the spacing clips 400 is visible in the tab slot 212 of a housing portion 200. The use of color-coded spacing clips 400 to indicate the match between a particular pair of sections 104 and a flexible tubing type would tend to lead designers to use a pair of identical spacing clips 400 for each tubing type rather than using a combination of two non-identical spacing clips 400 to get a gap 350 that is a different from a gap 350 available from any pair of identical spacing clips.

As an example of a color code system, for a particular type of flexible tubing 900 made with a tubing of a particular durometer value a set of four colors may be used for the spacing clips 400 to indicate that the sections 104 have spacing clips 400 adapted for specific tubing wall thicknesses.
For wall thickness of 0.063 inches, the spacing clips are white.
For wall thickness of 0.093 inches, the spacing clips are black.
For wall thickness of 0.125 inches, the spacing clips are gray.
For wall thickness of 0.188 inches, the spacing clips are green.

Those of skill in the art will appreciate that a color-coding scheme may have more or less than four values. A color-coding scheme may employ the use of stripes rather than only using solid colors. A color-coding scheme with many colors may indicate that a particular pair of spacing clips 400 within a section 104 is appropriate for a couple where the couple parameters are material type and wall thickness.

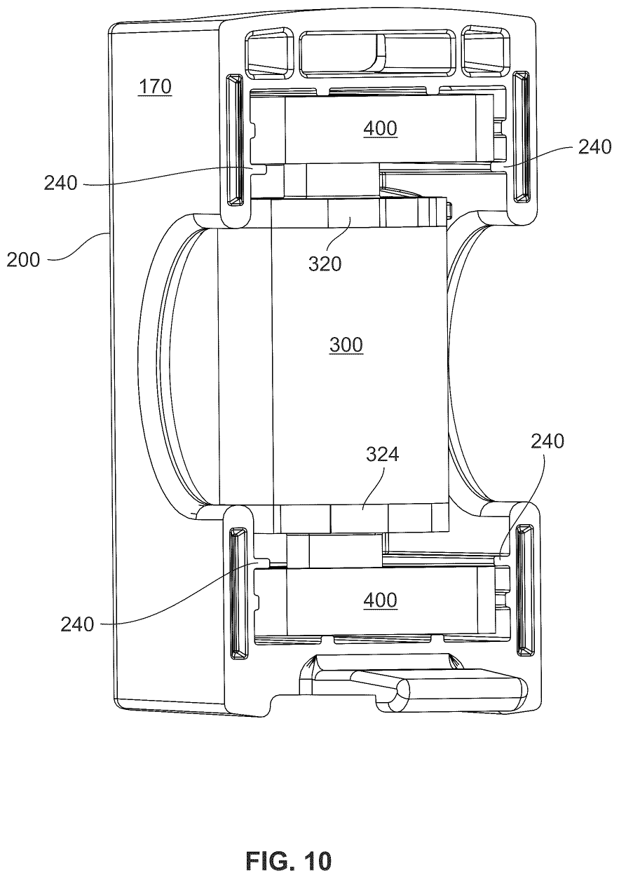

### FIG. 10

FIG. 10 shows the first section 170 (See FIG. 2) of the tube roller clamp 100. From this view, the pair of spacing clips 400 retaining the roller 300 are visible. The housing portion 200 maintains the up/down spacing of the spacing clips 400 through the use of clip rails 240.

### Limiting Tube Roller Clamp to One Direction of Travel.

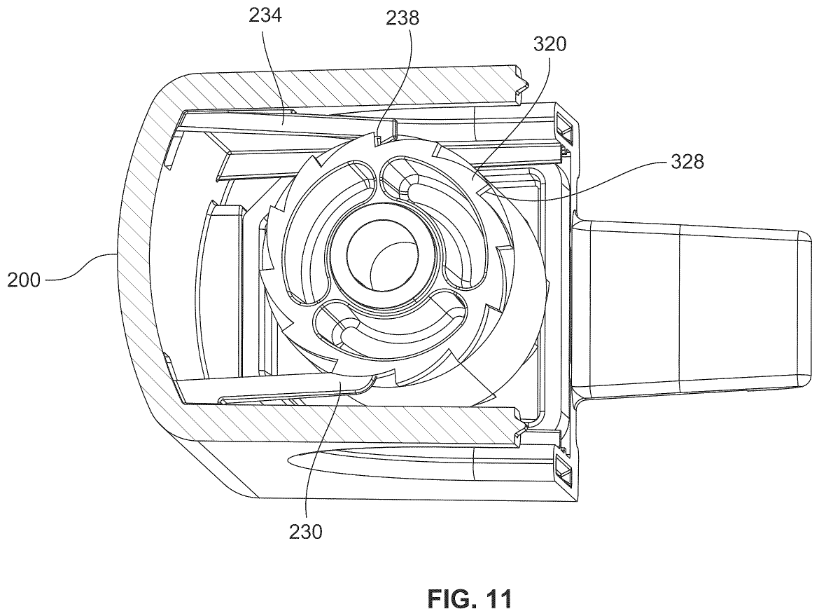

FIG. 11 is a cross section of FIG. 9 taken just above the first ratchet wheel 320. FIG. 11 shows two features that prevent movement of the roller 300 clockwise as viewed from above the roller 300. One feature is a pawl 230 that engages with ratchet teeth 328 as they move to the left to prevent clockwise rotation. The second feature is a retention arm 234 with a retention finger 238 that engages with the ratchet teeth 328 to prevent clockwise rotation as the ratchet teeth move to the right. A careful observer will note that the timing of the interaction of the pawl 230 with ratchet teeth 328 is offset from the interaction of the retention finger 238. This offset reduces the amount of backlash that is possible as the first ratchet wheel 320 moves slightly in the prohibited direction before either the pawl 230 or the retention finger 238 stops further rotation.

One of skill in the art could revise the housing portion 200 to preclude undesired rotation by modifying the housing portion 200 in other manners. One could use more than one pawl 230 or more than one retention arm 234 with protruding retention finger 238. The anti-rotation features could be separate components that are added to a housing portion 200 rather than formed integral with the housing portion 200.

### Method of Use.

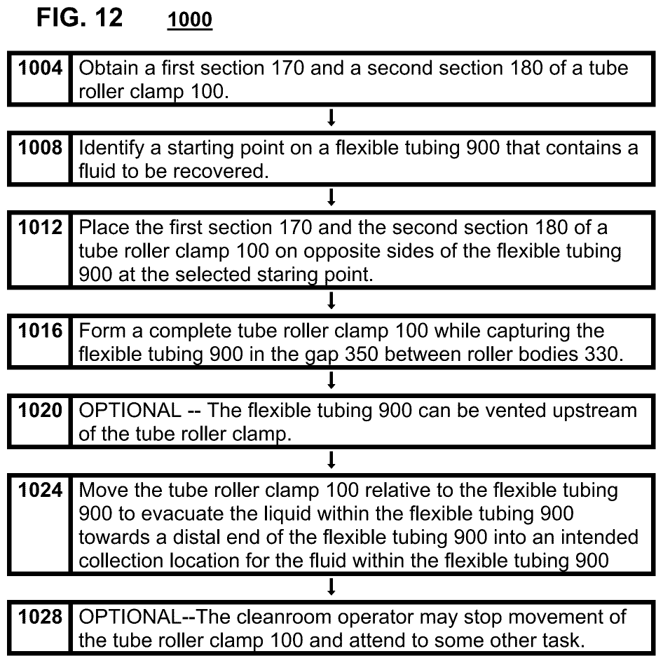

FIG. 12 contains process 1000 for use of a tube roller clamp 100 as taught within this disclosure.

Step 1004—Obtain a first section 170 and a second section 180 of a tube roller clamp 100. The first section 170 may be identical to second section 180 but this is not required.

Step 1008—Identify a starting point on a flexible tubing 900 that contains a fluid to be recovered.

Step 1012—Place the first section 170 and the second section 180 of a tube roller clamp 100 on opposite sides of the flexible tubing 900 at the selected staring point. Be mindful of the orientation of the first section 170 and the second section 180 as the tube roller clamp 100 may be limited to moving in a single direction.

Step 1016—Move the first section 170 and the second section 180 towards one another so that the first section 170 engages with the second section 180 to form a complete tube roller clamp 100 and capture the flexible tubing 900 in the gap 350 between roller bodies 330. The gap 350 is sized so that the flexible tubing 900 is at least flattened and is preferably flattened and compressed so that advancing the tube roller clamp 100 pushes the fluid forward while leaving very little fluid in the flexible tubing 900 behind the tube roller clamp 100.

Step 1020—OPTIONAL—The flexible tubing 900 can be vented upstream of the tube roller clamp so that the act of evacuating the fluid forward towards the collection location is not made more difficult by a partial vacuum in the tubing that no longer has fluid but is not allowed to vent. Testing of the tube roller clamp 100 has shown that venting is not required as the tube roller clamp 100 may be advanced even if the tubing behind (upstream) of the tube roller clamp 100 is not specially vented.

Step 1024—Move the tube roller clamp 100 relative to the flexible tubing 900 to evacuate the liquid within the flexible tubing 900 towards a distal end of the flexible tubing 900 into an intended collection location for the fluid within the flexible tubing 900.

Step 1028—OPTIONAL—The cleanroom operator may stop movement of the tube roller clamp 100 and attend to some other task. The weight of the tube roller clamp 100 is not significant as it is often less than 200 grams and the ratchet features preclude any significant backward movement of the tube roller clamp 100 relative to the flexible tubing 900. The compression of the flexible tubing 900 by the tube roller clamp 100 can hold fluid on the downstream side of the tube roller clamp 100 from passing upstream through the tube roller clamp 100 for fluid pressures up to 30 PSI or more. When the intended use of the tube roller clamp 100 does not include using the tube roller clamp 100 as a clamp but rather only as a tool for evacuating fluid from tubing, then the ratchet wheels and interactions with the housing may not be needed. Conversely, if the tube roller clamp 100 may be called upon to serve as a clamp to hold back fluid at a significant pressure, then a ratchet wheel (320 or 324) and some interaction with the tube roller clamp 100 to preclude movement of the rollers 300 in the reverse direction would be needed.

Dealing with Obstructions.

Sometimes there is a joint or other feature on the flexible tubing 900 so that the tube roller clamp 100 cannot proceed from a starting point to a desired end point. Thus, it may be necessary to open a pair of reversible connections between the first section 170 and the second section 180 so that the tube roller clamp 100 may be removed from the flexible tubing 900 next to the joint or other feature and the tube roller clamp 100 may be reapplied to the flexible tubing 900 downstream of the joint or other feature. A cleanroom operator can depress the exposed distal ends of the two housing tabs 184 (see FIG. 2) to allow the tube roller clamp 100 to be opened. Place the first section 170 and the second section 180 of the tube roller clamp 100 on opposite sides of the flexible tubing 900 downstream of the joint or other feature on the flexible tubing 900. Be mindful of the orientation of the first section 170 and the second section 180 as the tube roller clamp 100 may be limited to moving in a single direction.

Alternatively, the operator may move the first tube roller clamp 100 to close to the obstruction and then place a second tube roller clamp 100 just downstream of the obstruction while leaving the first tube roller clamp 100 in place. The operator would then move the second tube roller clamp 100 relative to the flexible tubing 900 to evacuate the liquid within the flexible tubing 900 towards the distal end of the flexible tubing 900 into the intended collection location for the fluid within the flexible tubing 900.

### Method of Manufacturing.

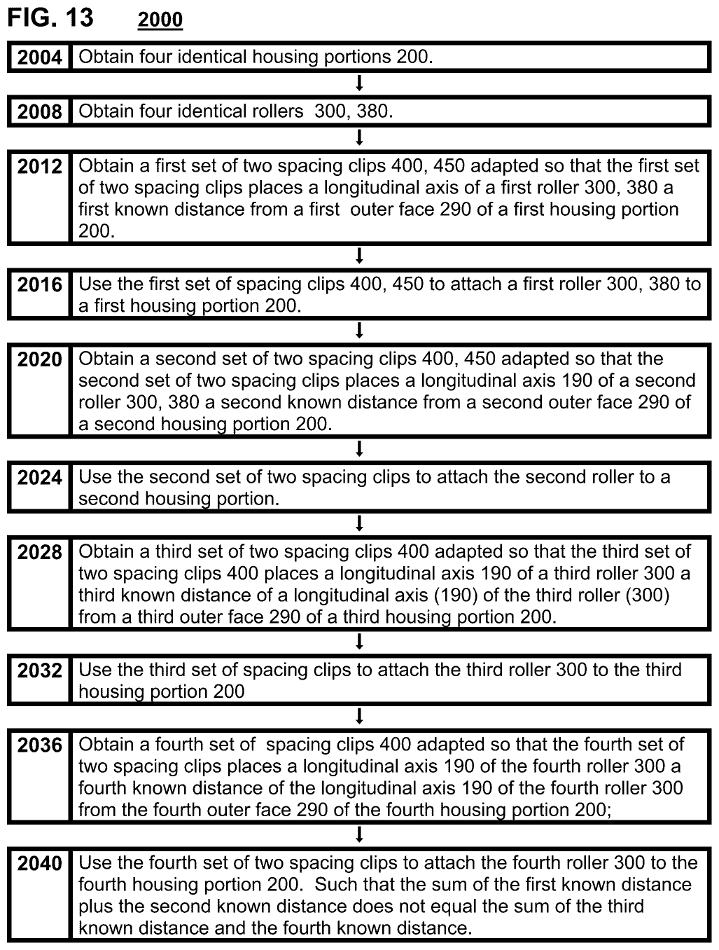

FIG. 13 is a flow chart for a process 2000 for creating a first kit for a first tube roller clamp 100 adapted for use with a first type of flexible tubing 900 having a first wall thickness 904 and then creating a second kit for a second tube roller clamp adapted for use with a second type of flexible tubing 900 having a second wall thickness 904 that is different from the first wall thickness 904.

Step 2004—Obtain four identical housing portions 200, with an outer face between a top end of the housing portion and a bottom end of the housing portion.

Step 2008—Obtain four identical rollers 300, 380 having roller bodies 330 between a pair of ends.

Step 2012—Obtain a first set of two spacing clips 400, 450 adapted so that the first set of two spacing clips places a longitudinal axis of a first roller 300, 380 a first known distance from a first outer face 290 of a first housing portion 200.

Step 2016—Use the first set of spacing clips 400, 450 to attach a first roller 300, 380 to a first housing portion 200.

Step 2020—Obtain a second set of two spacing clips 400, 450 adapted so that the second set of two spacing clips places a longitudinal axis 190 of a second roller 300, 380 a second known distance from a second outer face 290 of a second housing portion 200.

Step 2024—Use the second set of two spacing clips to attach the second roller to a second housing portion.

Step 2028—Obtain a third set of two spacing clips 400 adapted so that the third set of two spacing clips 400 places a longitudinal axis 190 of a third roller 300 a third known distance of a longitudinal axis 190 of the third roller 300 from a third outer face 290 of a third housing portion 200.

Step 2032—Use the third set of spacing clips to attach the third roller 300 to the third housing portion 200.

Step 2036—Obtain a fourth set of spacing clips 400 adapted so that the fourth set of two spacing clips places a longitudinal axis 190 of the fourth roller 300 a fourth known distance of the longitudinal axis 190 of the fourth roller 300 from the fourth outer face 290 of the fourth housing portion 200.

Step 2040—Use the fourth set of two spacing clips to attach the fourth roller 300 to the fourth housing portion 200. Such that the sum of the first known distance plus the second known distance does not equal the sum of the third known distance and the fourth known distance and thus a tube roller clamp 100 made using the first set of spacing clips 400, 450 and the second set of spacing clips 400, 450 would have a gap 350 between rollers 300, 380 that is suitable for a first type of flexible tubing 900 having a first wall thickness 904. Thus a tube roller clamp 100 made using the third set of spacing clips 400, 450 and the fourth set of spacing clips 400, 450 would have a gap 350 between rollers 300, 380 that is suitable for a second type of flexible tubing 900 having a second wall thickness 904 that is different from the first wall thickness 904.

Optionally, the first set of two spacing clips may be identical to the second set of spacing clips so that
the first roller is at first known distance of a longitudinal axis 190 of the first roller 300 from a first outer face 290 of a first housing portion; and
the second roller is at a second known distance of a longitudinal axis 190 of the second roller 300 from a second outer face 290 of a second housing portion; and
the first known distance equals the second known distance.

Optionally, the first tube roller clamp 100 and the second tube roller clamp 100 are each constrained to allow moving of the tube roller clamp in a single direction with respect to flexible tubing 900 and precluded from moving in a second direction opposite of the first direction.

Optionally, the kits may be further processed so that the kit is actually fully assembled tube roller clamp 100 that will need to be disassembled by an end user in order to engage flexible tubing 900. To ship fully assembled first tube roller clamp, one would invert the second housing portion relative to the first housing portion and engage the top end of first housing portion with the bottom end of the second housing portion and engage the bottom end of the first housing portion with the top end of the second housing portion to form a first tube roller clamp with a first gap 350 between the first roller 300 and the second roller, with the gap 350 adapted for use with a first type of flexible tubing 900 having a first wall thickness.

The process for the second roller clamp 100 would be analogous.

One of skill in the art will appreciate that the process 2000 could be modified to use eight identical spacing clips 400, 450 and four identical housing portions 200 but use a variety of rollers 300, 380 in order to make a first kit that makes a first tube roller clamp 100 with a first gap 350 appropriate for a first type of flexible tubing 900 with a first wall thickness 904 and a second that makes a first tube roller clamp 100 with a second gap 350 appropriate for a second type of flexible tubing 900 with a second wall thickness 904.

Likewise, one of skill in the art will appreciate that the process 2000 could be modified to use eight identical spacing clips 400, 450 and four identical rollers 300, 380 but use a variety of housing portions 200 in order to make a first kit that makes a first tube roller clamp 100 with a first gap 350 appropriate for a first type of flexible tubing 900 with a first wall thickness 904 and a second that makes a first tube roller clamp 100 with a second gap 350 appropriate for a second type of flexible tubing 900 with a second wall thickness 904.

### Roller Clamp Images.

The distinctive appearance of an assembled tube roller clamp 100 are set forth in a series of views as described below. To provide focus on the exterior, the components of the tube roller clamp 100 such as the rollers 300 or the interiors of the housing portions 200 are not included in these views in order to provide focus on the exterior.

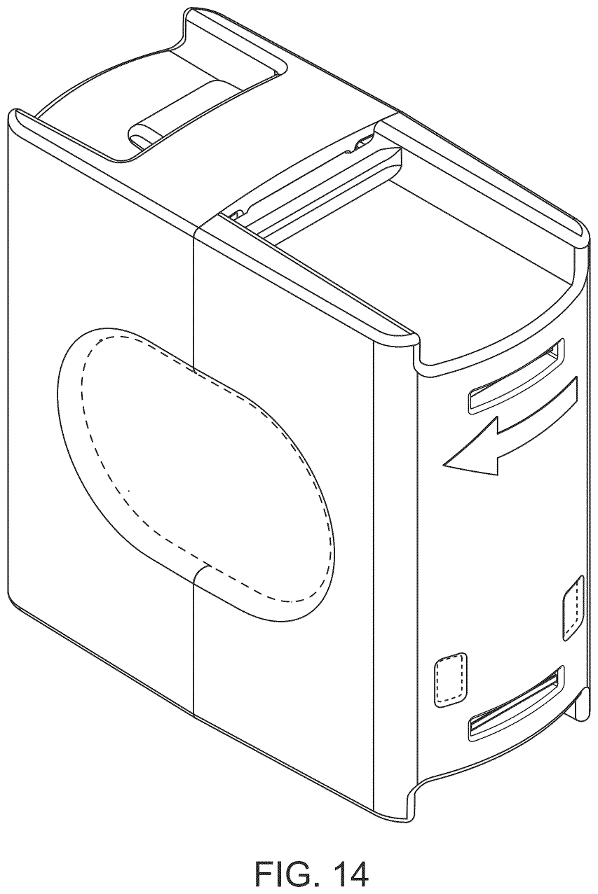

FIG. 14 is a top, front, right perspective view of the exterior of the tube roller clamp 100.

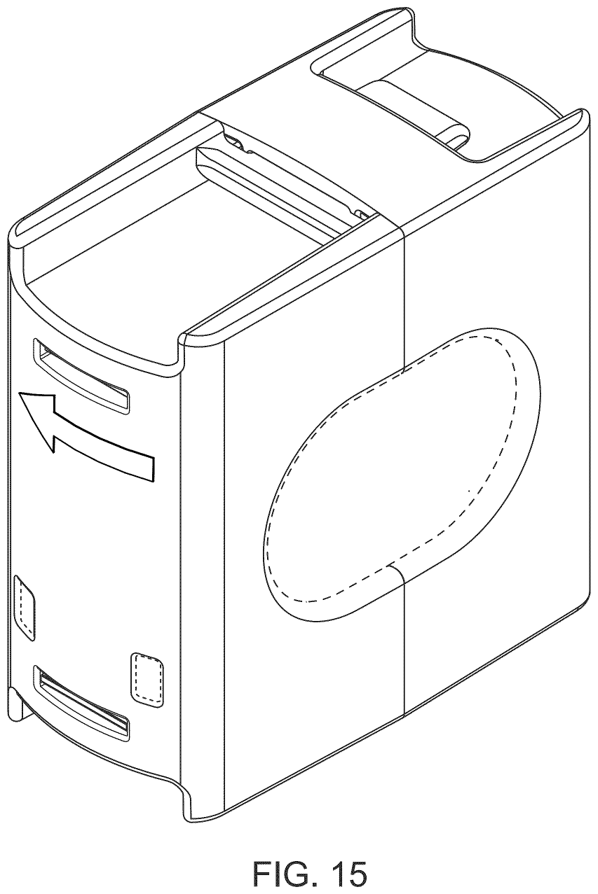

FIG. 15 is a top, rear, right perspective view of the exterior of the tube roller clamp 100.

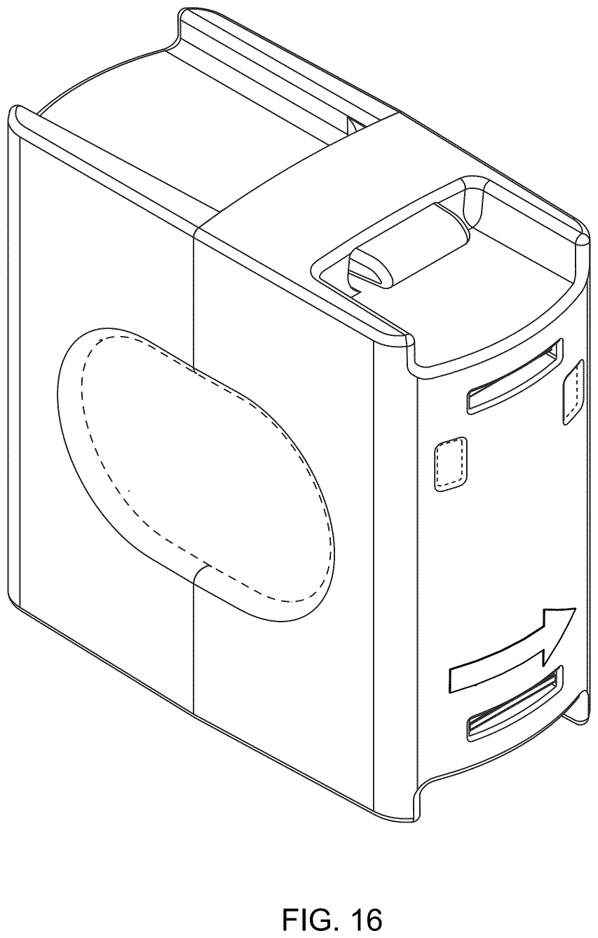

FIG. 16 is a top, rear, left perspective view of the exterior of the tube roller clamp 100.

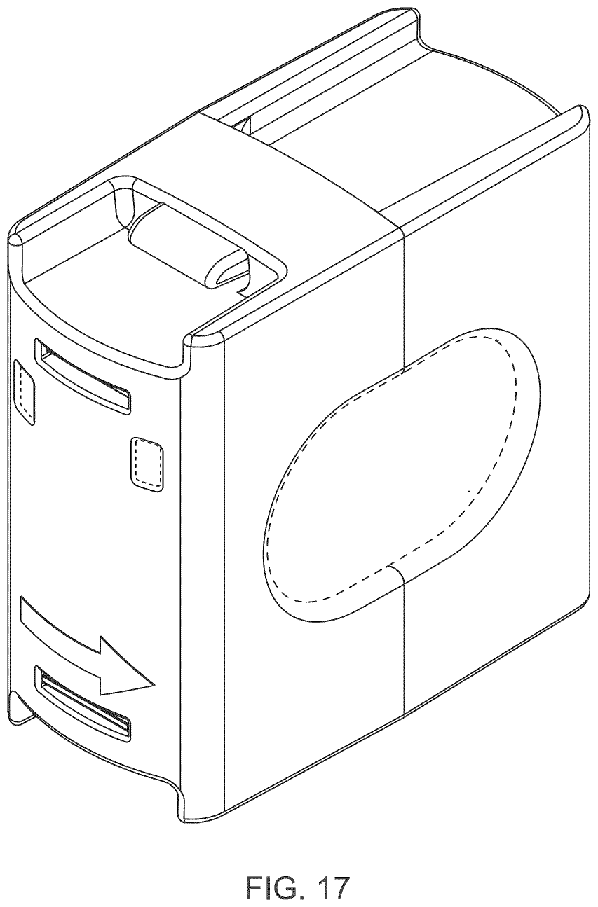

FIG. 17 is a top, front, left perspective view of the exterior of the tube roller clamp 100.

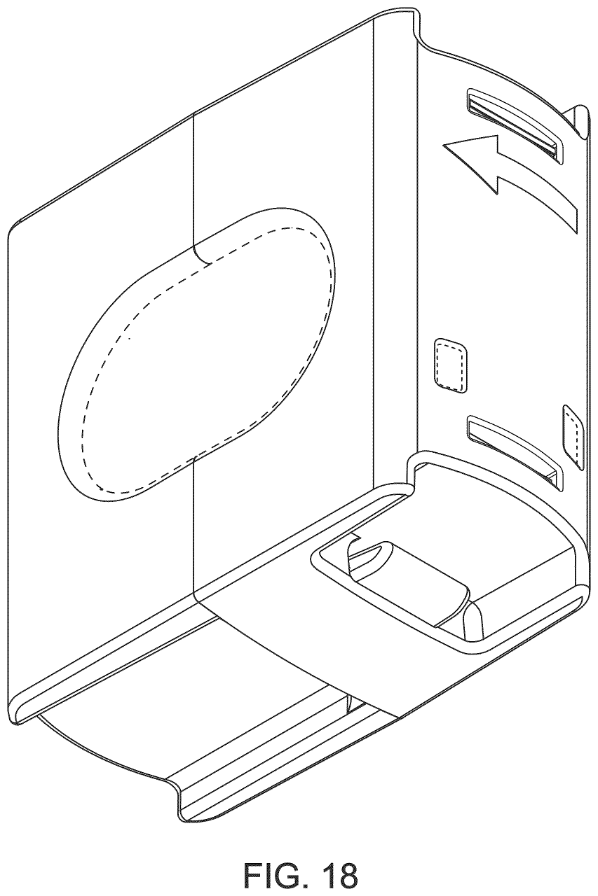

FIG. 18 is a bottom, front, right perspective view of the exterior of the tube roller clamp 100.

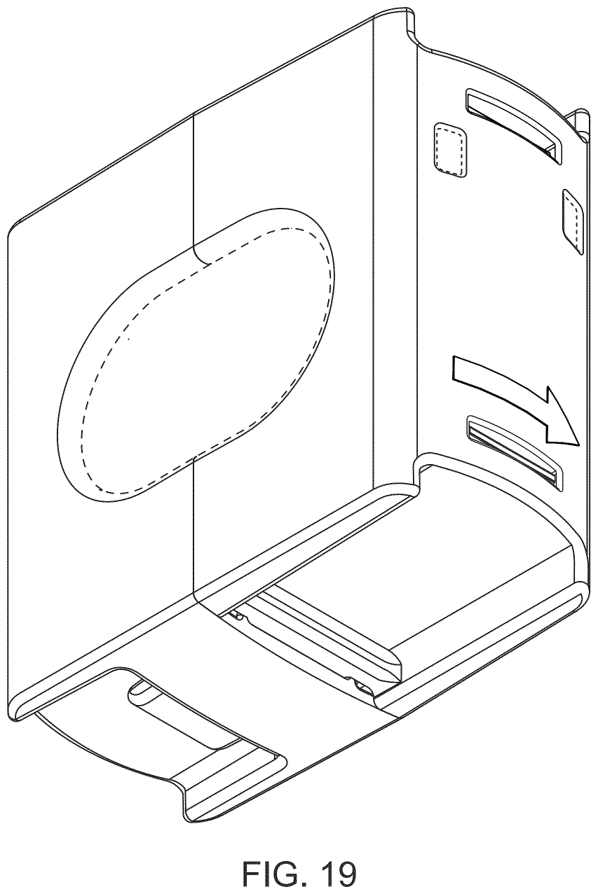

FIG. 19 is a bottom, rear, left perspective view of the exterior of the tube roller clamp 100.

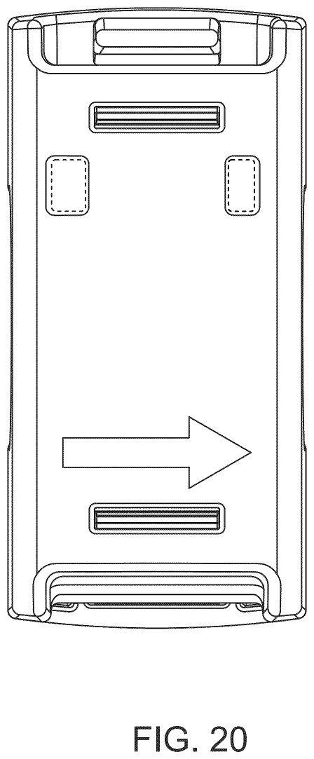

FIG. 20 is a left elevation view of the exterior of the tube roller clamp 100.

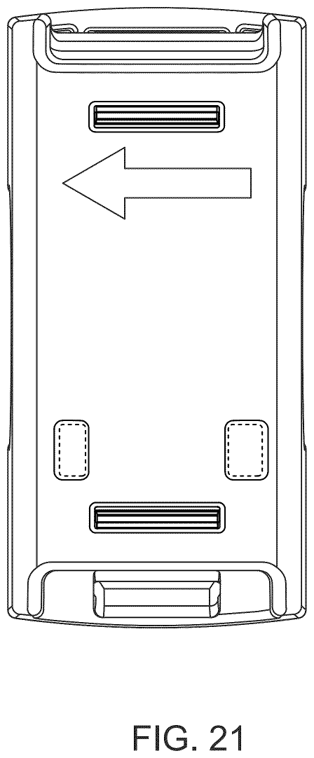

FIG. 21 is a right elevation view of the exterior of the tube roller clamp 100.

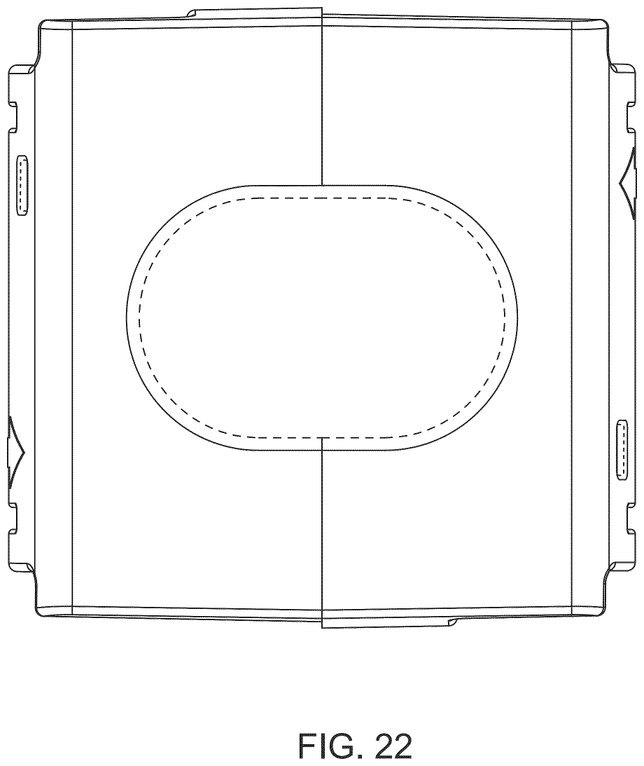

FIG. 22 is a front elevation view of the exterior of the tube roller clamp 100.

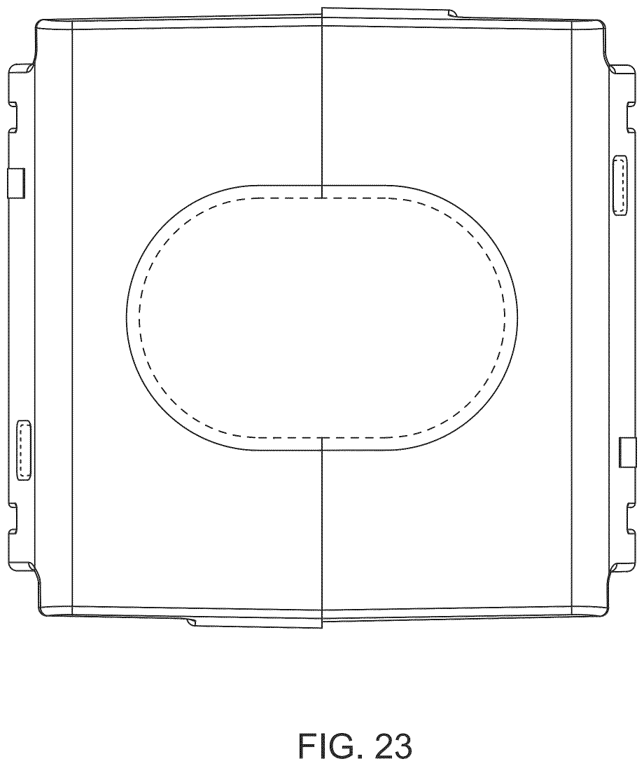

FIG. 23 is a rear elevation view of the exterior of the tube roller clamp 100.

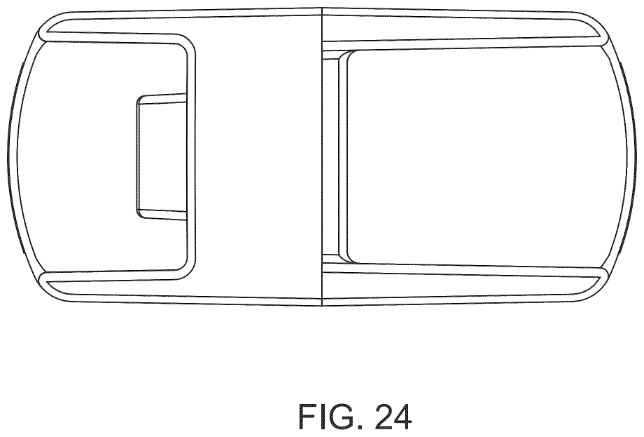

FIG. 24 is a top plan view of the exterior of the tube roller clamp 100.

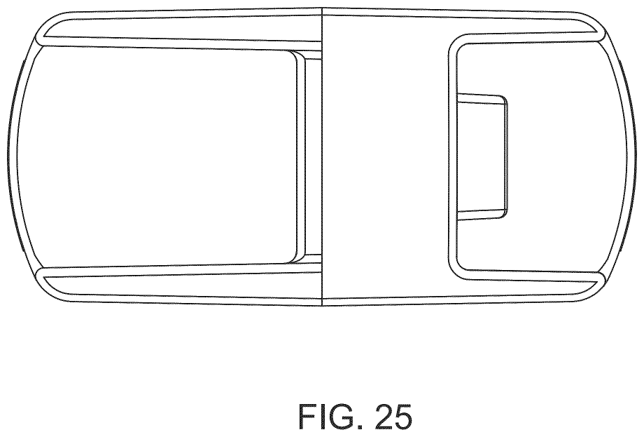

FIG. 25 is a bottom plan view of the exterior of the tube roller clamp 100.

### ALTERNATIVES AND VARIATIONS

### Direction of Travel.

The embodiment discussed above precluded rotation of the roller 300 in the clockwise direction as viewed from the top of the tube roller clamp 100. One of skill in the art could provide a tube roller clamp 100 that only allows counter-clockwise rotation of the rollers 300 as long as the rollers 300 had first ratchet wheel 320 and second ratchet wheel 324 that were arranged for that decision.

While it is preferred to have a ratchet mechanism to preclude movement of the tube roller clamp 100 upstream rather than downstream on a length of flexible tubing 900, this is not strictly required as the cleanroom operator may prefer a tube roller clamp 100 that can be assembled without regard to the direction of allowed travel and then rely on the cleanroom operator to know which way to move the tube roller clamp 100. Such a tube roller clamp 100 may not be a reliable clamp as the stripper mechanism 100 would not have a ratchet to preclude movement upstream and would have to rely on the friction caused by the roller bodies 330 compressing the walls of the flexible tubing 900.

### Spacing Clips.

While some designers may prefer to have four spacing clips 400 that are designed for a particular flexible tubing 900, this is not required. One could have two identical spacing clips 400 in a first housing portion 200 and a second set of identical spacing clips 400 different from the first set of identical spacing clips 400 in a second housing portion 200 in order to provide the appropriate gap 350 between roller bodies 330 for a particular flexible tubing 900.

The spacing clips 400 shown in various figures in this application abut one another. One of skill in the art will recognize that this may be a preferred choice but this would not be required as long as the spacing clips 400 are affixed to the housing portions 200.

### Alternative Spacing Clips.

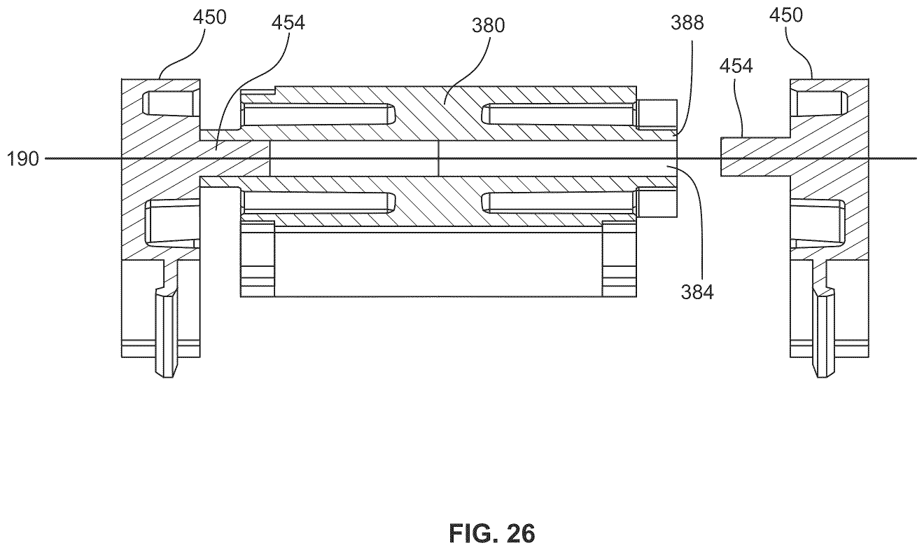

FIG. 26 shows a cross-section of a pair of alternative spacing clips 450 and an alternative roller 300. The alternative spacing clips 450 contains internal roller engagement bosses 454 that insert into openings 384 in the shaft ends 388 of alternative roller 380. One of skill in the art will appreciate that the interaction of the two spacing clips 450 and roller 380 allows the roller to rotate around a longitudinal axis 190 but not move a significant amount lateral to the longitudinal axis 190. Some de minimis movement is possible as the outer diameter of internal roller engagement bosses 454 will be somewhat smaller than the inner diameter of the openings 384 so that the roller 380 can rotate.

### Altering the Gap 350 Between Roller Bodies 330.

One of skill in the art will appreciate that the gap 350 between roller bodies 330 could be altered in one of three ways:

First—Alter the spacing clips 400 as noted above to alter a distance between the longitudinal axis 190 of the roller 300 and the outer face 290 of the housing portion 200. As noted, the spacing clips can be color coded to indicate the size of the gap 350 and thus the intended flexible tube.

Second—Alter the diameter of the roller bodies 330. While keeping the same spacing clip 400 and housing portion 200, a change in the diameter of the roller body 330 will alter the gap 350 between roller bodies 330 to strip fluid from the flexible tubing 900. Optionally, the roller bodies 330 or the rollers 300 in their entirety may be color coded to indicate the size of the gap 350 and thus the intended flexible tube.

Third—Alter the housing portion 200 so that there is a family of different housing portions 200, so that selection of a particular housing body will cause a roller 300 with a pair of spacing clips 400 to have a different has a different relationship between the outer face 290 of the housing portion 200 and the longitudinal axis 190 of the roller 300 than if a different housing portions 200. Optionally, the housing portions 200 may be color coded to indicate the size of the gap 350 and thus the intended flexible tube.

Fourth—A combination of two or all three of the three variation options listed above.

### Material Choices.

### Tube Roller Clamp.

The housing portion 200, roller 300, and spacing clip 400 may all be made out of the same material. But this is not required. Suitable materials choices for creating these components via plastic injection molding include Polypropylene, High Density Polyethylene or Polyketone. A careful observer may have noticed that the various views provided in the figures show voids in various components in keeping with good design practices of plastic injection molding. The void patterns will differ depending on the size of the tube roller clamp 100 that is being created. Further, designers may opt to make the components with a different process such as an additive printing process, or machining parts.

### Flexible Tubing.

While one type of flexible tubing 900 discusses above was Platinum Cured Silicone/Thermoplastic Elastomer, stripper assemblies 100 in accordance with teachings of the present disclosure may be used with a range of flexible tubing 900 such as TPE, PVC, PTFE, PFA, and TPU, among others. As noted above, the durometer value for the flexible tubing 900 combined with the wall thickness of the flexible tubing 900 will determine the optimal range of suitable gaps 350 between roller bodies 330. A tube roller clamp 100 as shown in FIG. 1 and the related figures has been found suitable to work with unreinforced flexible tubing 900 with a durometer value of not more than 80 (Shore A).

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

Where methods and/or events described above indicate certain events and/or procedures occurring in a certain order, the ordering of certain events and/or procedures may be modified. Additionally, certain events and/or procedures may be performed concurrently in a parallel process, when possible, as well as performed sequentially as described above.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed is:

1. A first section (170) and a second section (180) for forming a tube roller clamp (100) for evacuating fluid from flexible tubing (900) in a single flow direction, the first section (170) and the second section (180) each comprising:
a roller (300, 380) having a longitudinal axis (190) partially surrounded by a roller body (330) for contact with the flexible tubing (900);
a pair of spacing clips (400, 450) for holding the roller (300) in a fixed position relative to an outer face (290) of a housing portion (200);
wherein the roller (300) is constrained by the spacing clips (400, 450) from movement perpendicular to the longitudinal axis (190) but is able to rotate around the longitudinal axis (190); and
the first section (170) adapted to reversibly connect to the second section (180) after inversion to allow an end user to assemble the tube roller clamp (100) for evacuating fluid by capturing flexible tubing (900) between rollers (300, 380).

2. The first section (170) and second section (180) of claim 1 wherein:
the roller (300) a first journal (310) on a first end of a roller shaft (304), and a second journal (310) on a second end of the roller shaft (304); and
the spacing clips (400) each have a bushing (430) for holding the first journal (310) or the second journal of the roller (300) in the fixed position relative to a first outer face (290) of a first housing portion (200).

3. The first section (170) and second section (180) of claim 1 wherein:
the pair of spacing clips (450) each have an internal roller engagement boss (454) for insertion into an opening (384) in a shaft end (388) of roller (380); and
the internal roller engagement boss (454) used to hold the roller (380) in a fixed position relative to the outer face (290) of the housing portion (200).

4. The first section (170) and second section (180) of claim 1 wherein;
each roller (300, 380) has a ratchet wheel (320);
each of the first housing portion and the second housing portion (200) has at least one protrusion (230, 234) that engages with the ratchet wheel (320) to allow rotation of the roller (300) in a first direction when viewed from a first end of the roller (300) but not allow rotation of the roller (300) in a second direction, opposite to the first direction; and
thus, the assembled tube roller clamp (100) will only allow motion of the tube roller clamp (100) in one direction with respect to flexible tubing (900) captured between the roller body (330) in the first section (170) and the roller body in the second section (180).

5. The first section (170) and second section (180) of claim 4 wherein the housing portion (200) has a protrusion that prevents the ratchet wheel (320) from rotating in a prohibited direction as a ratchet tooth (328) moves towards the outer face (290) of the housing portion (200).

6. The first section (170) and second section (180) of claim 5 wherein the housing portion (200) has a protrusion that prevents the ratchet wheel (320) from rotating in a prohibited direction as a ratchet tooth (328) moves away from the outer face (290) of the housing portion (200).

7. The first section (170) and second section (180) of claim 4 wherein the housing portion (200) has a protrusion that prevents the ratchet wheel (320) from rotating in a prohibited direction as a ratchet tooth (328) moves away from the outer face (290) of the housing portion (200).

8. The first section (170) and second section (180) of claim 1 wherein;
each roller (300, 380) has a ratchet wheel (320);
each housing portion (200) has at least one protrusion (230, 234) that engages with the ratchet wheel (320) to allow rotation of the roller (300) in a first direction when viewed from a first end of the roller (300) but not allow rotation of the roller (300) in a second direction, opposite to the first direction; and
thus, the assembled tube roller clamp (100) will only allow motion of the tube roller clamp (100) in one direction with respect to flexible tubing captured between the first roller (300) and the second roller (300).

9. The first section (170) and second section (180) of claim 8 wherein the housing portion (200) has a protrusion that prevents the ratchet wheel (320) from rotating in a prohibited direction as a ratchet tooth (328) moves towards the outer face (290) of the housing portion (200).

10. The first section (170) and second section (180) of claim 9 wherein the housing portion (200) has a protrusion that prevents the ratchet wheel (320) from rotating in a prohibited direction as a ratchet tooth (328) moves away from the outer face (290) of the housing portion (200).

11. The first section (170) and second section (180) of claim 8 wherein the housing portion (200) has a protrusion that prevents the ratchet wheel (320) from rotating in a prohibited direction as a ratchet tooth (328) moves away from the outer face (290) of the housing portion (200).

12. The first section (170) and second section (180) of claim 1 wherein each spacing clip (400, 450) of the pair of spacing clips (400, 450) is adapted for use in either the first section (170) or the second section (180).

13. The first section (170) and second section (180) of claim 1 wherein the pair of spacing clips (400, 450) in the first section are identical to the pair of spacing clips (400, 450) in the second section (180).

14. The first section (170) and second section (180) of claim 1 wherein the pair of spacing clips (400, 450) in the first section is different from the pair of spacing clips (400, 450) in the second section (180).

15. The first section (170) and second section (180) of claim 14 wherein:
the pair of spacing clips (400, 450) in the first section positions the longitudinal axis (190) of the roller (300, 380) a first distance (494) from the outer face (290) of the housing portion (200); and
the pair of spacing clips (400, 450) in the second section positions the longitudinal axis (190) of the roller (300, 380) a second distance (496) from the outer face (290) of the housing portion (200); and
the first distance is (494) is different than the second distance (496).

16. The first section (170) and second section (180) of claim 1 wherein spacing clips (400, 450) each carry a marking that is visible after the spacing clip (400, 450) is inserted into the housing portion (200), the marking serving to indicate a distance between a longitudinal axis (190) of the roller (300, 380) and the outer face (290) of the housing portion (200).

17. The first section (170) and second section (180) of claim 16 wherein one pair of spacing clips (400, 450) carries a different marking from another pair of spacing clips (400, 450) as the distance between the longitudinal axis (190) the roller and the outer face (290) of the housing portion (200) in the first section (170) is different than the distance in the second section (180).

18. The first section (170) and second section (180) of claim 1 wherein both of the rollers (300, 380) have a marking that is visible in the tube roller clamp (100) to indicate a gap (350) between the roller body (330) for the first section (170) and the roller body (330) of the second section (180).

19. The first section (170) and second section (180) of claim 1 wherein both of the housing portions (200) have a marking that is visible in the tube roller clamp (100) to indicate a gap (350) between the roller body (330) for the first section (170) and the roller body (330) of the second section (180).

20. A kit for creating a tube roller clamp (100) for evacuating fluid from flexible tubing, the kit comprising:
a first section (170); and
a second section (180); wherein the first section (170) is adapted for reversible connection with the second section (180);
each of the first section (170) and the second section (180) comprising:
a roller (300, 380) with a roller body (330) in an intermediate section of the roller (300);
a pair of spacing clips (400, 450) adapted to engage the roller at both a first end of a roller shaft (304) or a second end of the roller shaft (304) to allow the roller (300, 380) to rotate around a longitudinal axis (190) of the roller (300, 380) but not move a substantial amount laterally relative to the longitudinal axis (190); and
the pair of spacing clips (400) with the engaged roller (300) attached to a housing portion (200) so that the longitudinal axis (190) of the roller (300) is a specific placement within the housing portion (200) so that when the first section (170) is reversibly connected to the second section (180) by an end user, a gap (350) between the pair of roller bodies (330) is appropriate to squeeze a particular type of flexible tubing (900) to evacuate fluid from the flexible tubing (900).

21. The kit of claim 20 for creating a tube roller clamp (100) wherein the each of the spacing clips (400) has a bushing (430) for receipt of a journal (310) of the roller shaft (304).

22. The kit of claim 20 for creating a tube roller clamp (100) wherein the each of the spacing clips (450) has an internal roller engagement boss (454) for engaging openings (384) in the ends (388) of the roller (380).

23. The kit of claim 20 wherein both the of the roller (300, 380) in the first section (170) and the roller(300, 380) in the second section (180) is able to rotate in a first direction when viewed from a first end of the roller (300, 380) but not able to rotate freely in a second direction, opposite to the first direction.

24. The kit of claim 20 wherein the first section (170) is identical to the second section (180).

25. The kit of claim 20 wherein both pairs of spacing clips (400, 450) are identical.

26. The kit of claim 20 wherein both rollers (300, 380) are identical.

27. The kit of claim 20 wherein both housing portions (200) are identical.

28. The kit of claim 20 wherein at least one component in the first section (170) and at least one component in the second section (180) is color coded to allow an end user to know that the tube roller clamp (100) formed from this kit will be suitable for a specific type of flexible tubing with a specific wall thickness.

29. A process for creating a kit for a tube roller clamp (100) for evacuating fluid from flexible tubing, the process comprising:
placing a first journal (310) of a first roller 300 in a first spacing clip (400);
placing a second journal (310) of the first roller (300) in a second spacing clip (400);
inserting the first spacing clip (400) and the second spacing clip (400) into a first housing portion (200) to form a first section (170) and placing the first roller (300) in a fixed relationship with the first housing portion (200);
placing a third journal (310) of a second roller 300 in a fourth spacing clip (400);
placing a fourth journal (310) of the second roller (300) in a fourth spacing clip (400);
inserting the third spacing clip (400) and the fourth spacing clip (400) into a second housing portion (200) to form a second section (180) and placing the second roller (300) in a fixed relationship with the second housing portion (200); and
wherein the tube roller clamp (100) to be formed by a user that connects to the first section (170) to the second section (180) will have a gap (350) between the first roller (300) and the second roller (300) that is appropriate to create a squeezed portion of a particular type of flexible tubing to be placed between the first roller (300) and the second roller (300).
